(19) United States
(12) Patent Application Publication
(10) Pub. No.: US 2016/0108187 A1
(43) Pub. Date: Apr. 21, 2016

(54) Biomaterial product based on sunflower seed shells and/or sunflower seed hulls

(71) Applicant: SPC SUNFLOWER PLASTIC COMPOUND GMBH, Garrel (DE)

(72) Inventors: Ulrich WENDELN, Garrel (DE); Ulrich MEYER, Garrel (DE)

(73) Assignee: SPC SUNFLOWER PLASTIC COMPOUND GMBH, Garrel (DE)

(21) Appl. No.: 14/890,963

(22) PCT Filed: May 14, 2014
(86) PCT No.: PCT/EP2014/059899

§ 371 Date: Nov. 13, 2015

(30) Foreign Application Priority Data
May 14, 2013 (DE) 10 2013 208 876.0
Aug. 16, 2013 (DE) 10 2013 216 309.6
Nov. 26, 2013 (DE) 10 2013 224 173.9
Nov. 29, 2013 (DE) 10 2013 224 646.3

(51) Int. Cl. C08J 5/04

(52) U.S. Cl. CPC C08J 5/045; C08J 2323/12; C08J 2499/00; C08J 2367/04; C08J 2355/02; C08J 2423/12; C08J 2399/00; C08J 2377/02

(57) ABSTRACT

The invention relates to a biomaterial product based on sunflower seed shells or sunflower seed hulls. The invention proposes the use, rather than of wood, bamboo, or other woodlike fiber products, of sunflower seed shells or sunflower seed hulls as starting material for the biomaterial products and the use thereof for producing such products, in order thereby to improve the existing biomaterials, including, in particular, by making them more cost-effective and enhancing their physical properties.

The invention relates to a biomaterial product based on sunflower seed shells or sunflower seed hulls. The basis for such products are biomaterials or biocomposites, which are already known, for example, in the form of “wood-plastic composites” (“WPC” for short). They are also referred to as “wood (fiber) polymer composites” or “wood-polymer materials”. The aforesaid biomaterials are composite materials which are processed thermoplastically and are produced from various fractions of wood—typically wood flour—plastics, and additives. They are mostly processed by modern methods of plastics technology such as extrusion, injection molding, or rotomolding, or by means of press techniques, though also by thermoforming.

Processing for WPCs is known to involve not only wood (especially wood flour) but also other plant fibers, as for example kenaf, jute, or flax.

The present invention aims to improve the existing WPCs, i.e., the existing natural fiber-reinforced plastics, and more particularly to reduce their costs in the production for the starting materials.

With the existing WPCs, the wood fraction is regularly above 20%; WPCs are known accordingly, for example, in which the wood fiber fraction or wood flour fraction is 50% to 90% and these materials are embedded in a plastics matrix of polypropylene (PP) or, less often, of polyethylene (PE). In view of the thermal sensitivity of the wood, processing temperatures of below 200° C. only are possible. At higher temperatures, the wood undergoes thermal transformations and decomposition, and this alters the properties of the material overall in an unwanted way.

With the natural fiber-reinforced plastics known to date, specific physical properties are also optimized by addition of additives. Such physical properties are, for example, the binding between wood and plastic, flowability, fire protection, coloring, and, particularly for exterior applications, the weathering, UV, and pest resistance.

It is also already known that a WPC can be produced on the basis of a mixture of 50% each of polyvinyl chloride (PVC) and wood fibers. These WPCs, based on thermoplastically processed thermosets, such as modified melamine resin, are likewise in development, as is the processing of woodlike products such as bamboo, the term then used being “bamboo plastic composites” (“BPC”). BPC classifies the WPC composite materials in which wood fibers have been replaced by bamboo fibers.

The advantages of the biomaterials described over traditional wood-based materials such as particle board or plywood are the unrestricted, three-dimensional moldability of the material and the greater resistance to moisture. In comparison with solid plastics, WPCs offer greater stiffness and a markedly smaller coefficient of thermal expansion. A further disadvantage of the existing biomaterials is that their breaking strength is less than that of sawn timber; the moldings with inserted reinforcements have greater breaking strength than solid moldings and than sawn timber. The water absorption of moldings with no final coating is higher than that of solid plastics moldings or moldings with a film coating or fluid coating.

The use of the biomaterials described to date as patio planking or for producing boards is known, as is the use of WPC particularly in the construction industry, the automobile and furniture industries, the outdoor sector for ground coverings (patios, swimming pools, etc.), facades, and furniture, particularly as a replacement for timber from tropical regions. There are also a number of WPC seating and shelving systems known. Other applications are writing implements, urns, and household appliances; WPC biomaterials are employed in the engineering sector as profiles for electrical insulation, and within the automobile industry, in particular, as interior door cladding and parcel shelves.

US 2009/0110654 A1 discloses a bio-plastic composite based on a series of biological materials apart from wood, including some based on sunflower constituents such as sunflower seed shells. This plastic material may also come from the group of the polyolefins, polyacetals, polyamides, polyesters, or cellulose esters and cellulose ethers. The fraction of vegetable fiber in this case is regularly between 25% and 50%; in the case of hydrolyzed vegetable material, the fraction may even be significantly higher. The objective pursued is that of producing a low-odor or controlled-odor bio-plastic composite, with addition of odor-controlling reagents as well.

US 2002/0151622 A1 discloses a plastic composite for the absorption of volatile organic compounds (VOCs), for which cellulosic materials, including sunflower seed shells, for instance, are employed within a very broadly couched range (3-80%).

For the bio-plastic composites disclosed in US 2009/0110654 A1 and US 2002/0151622 A1, including those based on sunflower seed shells, the processing temperatures employed are only up to 204° C. Higher temperatures are expressly not recommended, owing to possible damage to the composite.

Lastly, in 2010 at the National Farm Management Conference, Ulven et al. presented the production of a bio-plastic composite based on plastics such as, among others, PP, PE, ABS, and also PMMA, in which vegetable fibers such as sunflower seed shells are used in a fraction of between 5% and 50%. Nothing, however, was said about the temperature stability of the bioplastic. Nor were there any observations concerning precise description or delimitation of parameters in relation to the nature of the sunflower seed shells.

A primary object of the invention is to improve the existing WPC biomaterials as a basis for corresponding biomaterial products, including in particular to make them more cost-effective and to enhance their physical properties. In addition, the intention is to enable processing of the inventively compounded material by injection molding.

This stated primary object is achieved by a biomaterial product having the features according to claim 1.

Advantageous embodiments are disclosed and claimed in the dependent claims.

The proposal in accordance with the invention is to make use, rather than of wood, bamboo, or other woodlike fiber products, of—in particular—sunflower seed shells or sunflower seed hulls as a starting material (basis) for a biomaterial, and to use them for producing such products.

In accordance with the invention, the stated object is solved by a method of the invention for producing a biomaterial product (biomaterial) based on

sunflower seed shells or sunflower seed hulls, comprising the following steps:
providing or producing a compounded material,
   the material resulting from compounding of a sunflower seed shell material or sunflower seed hull material with a plastics material,
and
processing the compounded material, or a compounded material resulting therefrom by treatment, at a temperature of 260° C. or less to form a biomaterial product,
   the total fraction of sunflower seed shell material or sunflower seed hull material in the biomaterial product being in the range from 20 to 60 wt %, based on the total mass of the biomaterial product, and
the biomaterial product preferably possessing
   a density of 1 g/cm³ or greater than 1 g/cm³, and/or
   an elasticity modulus of 1000 MPa or greater than 1000 MPa, and/or
   a tensile strength of 10 MPa or greater than 10 MPa, and/or
   an elongation at break of 3% or greater than 3%.

Particularly preferred is a method of the invention (as referred to above or below as being “preferred/preferable”) where the fraction of the sunflower seed shell material or sunflower seed hull material in the biomaterial product is in the range from 30 to 50 wt %, based on the total mass of the biomaterial product, preferably 45 wt %, based on the total mass of the biomaterial product.

Sunflowers, as the original biological source of the sunflower seed shells or sunflower seed hulls which are used as a basis of a biomaterial product of the invention, are cultivated in all locations of our world. The primary objective of sunflower production is, fundamentally, to obtain sunflower seeds and in particular the contents of them. Before the seeds are processed, the sunflower seed must be hulled, meaning that the actual sunflower kernel is freed from its shell or hull. In sunflower kernel production, these shells or hulls arise in large quantities, and, as an unwanted byproduct of sunflower kernel production, may be used for other purposes as well, as for example as cattle feed or a cattle feed constituent, as a fuel, as biomass in biogas plants, etc.

The advantage of the sunflower seed shells or sunflower seed hulls is first and foremost that they not only arise in large quantities but that on account of their small size they are already in a relatively small form and therefore need only minimal further working, comminution for example, in order to form the starting material (in accordance with the invention, sunflower seed shell material or sunflower seed hull material) for a likewise inventive compounded material (“SPC”, “sunflower-plastic composite”, biocomposite) which is processed to a biomaterial product at a temperature of 260° C. or less. Accordingly, the comminution or grinding of the sunflower seed shells or sunflower seed hulls is associated with much less energy expenditure than the production of wood flour for WPC production.

The particular advantage of using and employing sunflower seed shells or sunflower seed hulls is also that they are very suitable for use inter alia for an SPC which serves for producing packaging, for example a bottle or canister, and in particular for food packaging.

The present invention therefore also relates to the use of a compounded material (SPC, sunflower-plastic composite) as defined above or below for producing a biomaterial product (as defined above or below and identified as “preferred/preferable”), the biomaterial product preferably forming or being a constituent of packaging, a furnishing item, a layable sheetlike element, and an automobile part.

In particular, however, it has emerged in a first experiment that comminuted or ground sunflower seed shells or sunflower seed hulls are superlatively suitable for processing as SPC and can be used superlatively for producing food packaging which in no way alters the taste of the stored food item, unfavorably or in any other way.

Preferred accordingly likewise is an inventive use of a compounded material (SPC, sunflower-plastic composite) as defined above or below for producing a biomaterial product (as defined above or below and identified as being “preferred/preferable”), the packaging being food packaging, preferably a canister or a bottle or a film.

The invention therefore also represents a very sustainable approach to producing packaging material or the like in a manner which preserves resources.

Preference is also given to an inventive use of a compounded material (SPC, sunflower-plastic composite) as defined above or below for producing a biomaterial product (as defined above or below and identified as being “preferred/preferable”), the furnishing item being selected from the group consisting of doors, pots, flower planters, boxes, transport boxes, and containers.

Especially preferred, additionally, is an inventive use of a compounded material (SPC, sunflower-plastic composite) as defined above or below for producing a biomaterial product (as defined above or below and identified as being “preferred/preferable”), the layable sheetlike element being a floorboard or patio planking, preferably decking.

The processing of the comminuted and/or ground sunflower seed shells or sunflower seed hulls may take place advantageously as for the production of wood-plastic composites.

The fraction of the sunflower seed shells or sunflower seed hulls in this case may be 30% to 90% of the biomaterial product, with the plastics matrix of the biomaterial product, also referred to in the present disclosure as plastics material or polymer matrix, comprising preferably one, two or more constituents, the constituents being selected from the group consisting of: polypropylene (PP), polyethylene (PE), acrylonitrile-butadiene-styrene (ABS), polylactic acid (PLA), polystyrene (PS), polyvinyl (PV), polyvinyl chloride (PVC), polyamide (PA, preferably of the type PA6), cellulose, cellulose acetate (CA), celluloid, cellophane, vulcanized fiber, cellulose nitrate, cellulose propionate, cellulose acetobutyrate, starch, lignin, chitin, casein, gelatin, and polyhydroxy-alkanoate (PHA).

In a preferred method of the invention, the plastics material is selected from the group consisting of: polypropylene (PP), polyethylene (PE), polyvinyl chloride (PVC), acrylonitrile-butadiene-styrene (ABS), polylactide (PLA), polystyrene (PS), polyamide (PA), and mixtures thereof.

Plastics based on polyhydroxyalkanoates (PHA), also referred to as polyhydroxy-fatty acids (PHF), are already known as such. PHAs are naturally occurring polyesters, mostly linear and rarely branched, which consist of saturated and unsaturated hydroxyalkanoic acids (also: hydroxy-fatty acids). In general, therefore, a multiplicity of combinations of different hydroxyalkanoic acid monomers are possible, and so PHAs may take the form not only of monomers but also of copolymers. This multiplicity of very different PHA-constructing monomers ensures in turn, through variation possibilities in their linkage or linkages to one another and in their (quantitative) ratio to one another in the polymer, that there is a multiplicity of possible PHA plastics, with a great variety of properties and with a host of fields for application.

In general, PHAs are water-insoluble, thermoplastically shapeable, nontoxic, and biodegradable.

Sunflower seed shells and sunflower seed hulls can be processed as part of a compounded material, on account of their thermal sensitivity, at temperatures, indeed, of 260° C.

In a particularly preferred method of the invention, the processing of the compounded material takes place at a temperature of 255° C. or less, 250° C. or less, 240° C. or less, more preferably at a temperature in the range from 100° C. to 260° C., preferably in the range from 150° C. to 250° C.

Processing of the compounded material at temperatures in the range from 210° C. to 240° C., preferably of 230° C. or less, is possible; at temperatures in the region of 240° C. or more, there might be instances of thermal transformation or decomposition.

The addition of additives optimizes specific physical properties of the biomaterial of the invention, as for example the binding between the sunflower seed hulls or sunflower seed shells and the plastic, the flowability of the compounded material, the fire protection, the coloring, and, particularly for food applications, the oil, UV, and pest resistance.

Preferred is a method of the invention (as defined above or below and identified as being “preferred/preferable”) where the biomaterial product possesses an elasticity modulus of 2000 MPa or greater than 2000 MPa.

Additionally preferred is a method of the invention (as defined above or below and identified as being “preferred/preferable”) where the biomaterial product possesses a tensile strength of 20 MPa or greater than 20 MPa.

Also preferred is a method of the invention (as defined above or below and identified as being “preferred/preferable”) where the biomaterial product has a softening temperature in the range from 50 to 80° C., preferably not greater than 75° C.

Particularly preferred is a compounded material of PP (polypropylene) and/or PE (polyethylene) and/or ABS (acrylonitrile-butadiene-styrene) plastic on the one hand and sunflower seed shells or sunflower seed hulls on the other hand, each at 50%. In a compounded material of this kind, for example, a fraction of PP and a fraction of (ground) sunflower seed shells or sunflower seed hulls are used in equal quantity, the sunflower seed shells or sunflower seed hulls possessing the properties described in the present specification, with regard to their grain size, their water content, their oil content (also defined “fat fraction” in the present specification), etc. Instead of the plastics described such as PP, PE or ABS it is also possible for PVC (polyvinyl chloride) or PS (polystyrene) or PLA (polylactide) to be used. The processing temperature is then occasionally determined by the plastics component if its maximum processing temperature is below that of the shell material.

Especially preferred is a method of the invention (as defined above or below and identified as being “preferred/preferable”) where the material results from compounding of a sunflower seed shell material or sunflower seed hull material with a polyamide, preferably of type PA6, and also one, two, or more than two additives, preferably of the type Irgafos 168 and/or Irganox 1076 and/or Licocene, preferably of type PP MA, 7452 TP,
and
the fraction of the polyamide is in the range from 65 to 75 wt %, based on the total mass of the biomaterial product,
and
the fraction of the sunflower seed shell material or sunflower seed hull material is in the range from 28 to 35 wt %, based on the total mass of the biomaterial product.

The compounded material of the invention (sunflower-plastic composite, SPC, also defined as biomaterial or biocomposite in the present specification) may in this case be processed by a method which has already been introduced effectively in plastics production. Particularly preferred is processing by injection molding (at 210 to 230° C., for example), although any other form of plastics processing is readily conceivable and possible.

Especially preferred is a method of the invention where the processing of the compounded material, or of a compounded material resulting therefrom by treatment, to form a biomaterial product takes place by means of one, two or more, or all methods selected from the group consisting of
extrusion, injection molding, rotomolding, press techniques, and thermoforming methods.

In the case of injection molding, the compounded material, i.e., the mixed material consisting of plastic on the one hand and comminuted and/or ground sunflower shells or sunflower hulls on the other, must be able to be metered without problems and homogenously, so that all of the parts of the melt have effective flowability.

The grain size of the sunflower seed shell material or sunflower seed hull material is therefore preferably in the range from 0.05 mm to 2 mm, more preferably being a grain size of below 1 mm. Especially preferred for the sunflower seed shell material or sunflower seed hull material is a grain size in the range from 0.01 to 0.5 mm, very preferably a grain size in the range from 0.1 to 0.3 mm, and in case of need a grain size of this kind is also achieved if a predominant part, such as 90%, for example, of the hull material is situated within the abovementioned range and 10% to 20% is outside this range (owing to inaccuracies of tolerance).

The sunflower seed shell material or sunflower seed hull material preferably has a high degree of drying, meaning that it has a water fraction in the range from 1 to 10 wt %, preferably in the range from 4 to 8 wt %, more preferably in the range from 5 to 7 wt %, based in each case on the total mass of the sunflower seed shell material or sunflower seed hull material.

The sunflower seed shell material or sunflower seed hull material also possesses a fat fraction of 6 wt % or less, preferably of 4 wt % or less, more preferably in the range between 1 to 2 wt %, based in each case on the total mass of the sunflower seed shell material or sunflower seed hull material.

Preference is therefore given additionally to a method of the invention where the sunflower seed shell material or sunflower seed hull material possesses
a water fraction in the range from 1 to 10 wt %, preferably in the range from 4 to 8 wt %, more preferably in the range from 5 to 7 wt %,
and/or
a grain size in the range of 3 mm or less, preferably in the range from 0.01 to 1 mm, more preferably in the 0.1 to 0.3 mm range, and so
   the elasticity modulus and/or the tensile strength of the biomaterial product are increased,
and/or
a fat fraction of 6 wt % or less, preferably of 4 wt % or less, more preferably in the range between 1 to 2 wt %,
   based in each case on the total mass of the sunflower seed shell material or sunflower seed hull material.

In view of the sunflower seed hull geometry and in view of the low impact strength, the wall thicknesses in injection molding are designed to be thicker than in the case of pure plastics pellets. The substantially higher heat distortion resistance is advantageous, and gives the composition stiffness at elevated temperatures. SPC moldings can therefore be demolded at higher temperatures.

As already described above, the invention is especially suitable for use of an SPC for producing packaging, preferably food packaging, more preferably a canister, a bottle, or the like. Packaging of this kind may also, if required, be provided with an internal and/or external coating, in order to make the overall packaging more resistant and to rule out any possible sensory effects on the packaged material, such as oil, beverages, etc., for example, by the packaging material, i.e., the SPC.

In the present specification, the use of sunflower seed hulls or sunflower seed shells is the preferred use of a hull for producing a “bio-plastic composite”.

As already mentioned, it is already known for natural fiber-reinforced polymers that wood and/or wood fibers and the like can be used as compound material, in order thus to produce a wood-plastic compound material which is then further-processed later. In such further processing, the compound material is melted or in any event greatly heated, in order to render it flowable and therefore amenable to processing. But in the case of wood-plastic composite materials, attainment of a temperature of 200° C. is already highly problematic, since the thermal load on the wood is too high above the temperature range upward of 200° C., meaning that the (wood) material suffers. The polymers, i.e., polymer matrixes such as polyethylene (PE), polypropylene (PP), polystyrene (PS), or polyvinyl chloride (PVC), however, are unsuitable for the majority of structural applications, owing to reasons including their creep behavior and their low heat distortion resistance, unless they can also be processed at high temperatures, namely at temperatures well above 200° C., in injection molding or the like, for example. Load-bearing elements made from wood-plastic composite material must also have significantly better mechanical properties than PP- or PE-based wood plastic composites (WPC).

As mentioned, the use of high-performance plastics as a matrix is very limited, as a result of the mandated melting temperature (up to 200° C.) Added to this, the very high price of possible engineering polymers makes them unlikely to be economically viable anymore.

Tests have now shown that the SPC biomaterial of the invention can be produced even at processing temperatures up to 300° C., and that processing in the range from 220° C. to 250° C. is never associated with any degradation in material in any case, and therefore that significant improvements can be offered in the mechanical properties at an acceptable price.

The compounded material of the invention, obtainable by processing of a sunflower seed shell material or sunflower seed hull material as defined above and below, can be put to outstanding use and employed for the production of biomaterial products, which may serve as a constituent of or even as a complete replacement for plastics products used up until now, in the automotive sector, among others, or in the form of films and also carrier bags, packaging, industrial and consumer goods, boards/planks, decking, containers, baskets, refuse bins, and furniture.

For the automotive sector, examples of applications envisaged include the shells of wheel housings (known as wheel arches), the engine cover, or else the underbody cladding. In the sector of films and carrier bags, particular mention should be given to the use of the biomaterial of the invention for the production of silo films, packaging films, and carrier bags; in the packaging and containers sector, particular mention should be given in accordance with the invention to the production of food packaging, refuse bins, or plastic canisters and corresponding containers. A particular inventive use contemplated for the biomaterial of the invention is also the production of beverage crates, bread boxes, and plant pots, and also, in the house and garden sector, the production of furnishings, examples being chairs, benches, and tables, and also of patio planking and doors.

Lastly it has emerged that as a result of the volume fraction of the sunflower seed shell material on the one hand and/or its grain size on the other, the impact strength of the biomaterial of the invention can be adjusted in a desired manner.

As mentioned, the biomaterial product or compounded material (biocomposite) of the invention comprises sunflower seed shells or sunflower seed hulls, and so, therefore, the biomaterial product or biocomposite of the invention has sunflower seed shells or sunflower seed hulls as a base material. Where the present specification refers to sunflower seed hull material, this is synonymous with sunflower shells, sunflower seed shells, and sunflower hulls. What is referred to is always the shell, hull, or husk material of sunflower kernels or seeds.

The present invention also relates to a biomaterial product producible by a method as defined above or below.

If, after the shell material has been separated from the kernel, in other words after shelling or hulling, the shell material has parameters in terms of water content, grain size or fat fraction which differ from that used as particularly advantageous in accordance with the present specification, the material is treated and processed accordingly. If, for example, the shell material has a water content of 15%, this water content is reduced by drying in a targeted manner to the desired level (e.g., 8% or less). If the shell material after shelling has a grain size which is too high, then further grinding will achieve the desired grain size. If the shell material after shelling has too high a fat fraction, a customary fat absorption operation (also possible by thermal treatment) will targetedly reduce the fat fraction in the shells.

Typical compositions of a biomaterial are given below, and on the one hand comply with desired technical properties, while on the other hand being markedly more advantageous than existing plastics or bioplastics.

### WORKING EXAMPLE 1

### “ABS/SPC 30” Bioplastic

520 kg of ABS (acrylonitrile-butadiene-styrene), 300 kg of shells, 30 kg of additive (odor), 30 kg of additive (impact strength), 30 kg of additive (moisture), 30 kg of additive (flow property), 30 kg of additive (adhesion promoter), 30 kg of additive (stripping agent).

A mixture of these materials is then supplied in the usual way to a compounding process, and so the desired biomaterial product can then be produced in the desired form from the compounded material resulting from compounding, the production being by means, for example, of extrusion or injection molding or rotomolding or press techniques or thermoforming.

An example of suitable adhesion promoter additive is the product “SCONA TPPP 8112 FA” (adhesion modifier for polypropylene-natural fiber compounds and in TPE-S compounds) from BYK, Additives & Instruments, Technical Data Sheet, Issue 07/11, a product from, and a company of, the ALTANA group. The Technical Data Sheet for this product is listed as table 1.

A suitable stripping agent additive is the product “BYK-P 4200” (stripping agent for reducing odor and VOC emissions in thermoplastic compounds), Data Sheet X506, Issue 03/10, from BYK Additives & Instruments, a company of the ALTANA group. The Data Sheet for the product is attached as table 2,

A product that appears to be particularly suitable as additive to counter odor generation is “Ciba IRGANOX 1076” (phenolic primary antioxidant for processing and long-term thermal stabilization), a product from Ciba. A suitable further additive for process stabilization is the product “Ciba IRGAFOS 168” (processing stabilizer) from Ciba. A particularly suitable polypropylene material is the product “Moplen EP300K—PP—Lyondell Basell Industries”. A Data Sheet for this product is attached as table 5.

### WORKING EXAMPLE 2

Another composition of another compounded material (biomaterial) with the in-house name “PP/SPC 50” is as follows:

45% of Moplen EP300K PP pellets
50% of sunflower shells
Irgafos 168, powder, 0.20%
Irganox 1076, powder, 0.30%

### BYK P 4200, 2.00%

Scona TPPP 8112 FA, powder, 2.5%

The abovementioned constituents are compounded in the usual way, and the resultant compounded material can then be processed for the production of a desired biomaterial product by means of a method described above or below in the present application—for example, extrusion, injection molding, thermoforming, rotomolding, press techniques.

When the term compounding is used in the present application, it means the processing of a sunflower seed shell material or sunflower seed hull material with a plastics material, and this means specifically the value-added process which embraces the specific optimization of the property profiles of the biomaterial of the invention through admixture of adjuvants (fillers, additives, etc.). The compounding process takes place by way of example in an extruder (e.g., a twin-screw extruder, but it is also possible to use a contrarotating twin-screw extruder or else a planetary-gear extruder and co-kneader for this purpose) and comprises inter alia the process operations of conveying, melting, dispersion, mixing, devolatilizing, and compression.

The purpose of the compounding process is to provide, from a raw plastics material, a plastics molding composition with the best-possible properties for processing and use.

The compounding process finally produces an outgoing biomaterial (defined above or below as compounded material; in the form, for example, of pellet, granule, or the like) which comprises the individual outgoing constituents, i.e., shell material, polypropylene, additives, etc., and specifically in mixed form. The compounded material (biomaterial) is generally produced in the form of an intermediate product taking the form of a pellet or the like, and so can then be further processed in a plastics-processing machine to produce the desired biomaterial product, in an injection-molding machine, for example.

By means of the invention it is possible to combine a byproduct of sunflower processing with plastic and thus, in a manner that conserves resources and is sustainable, to achieve a reduction of from 30% to 70% in the dependency of plastics production on petroleum.

Associated with this is the very favorable effect that the processing of the compounded material (biocomposite or biomaterial) of the invention also has on the CO₂ cycle, and also on the lifecycle assessment of the products produced therefrom.

By means of the invention it is also possible to achieve the processing of the biomaterial of the invention—which can also be called biopolymer—at temperatures of up to 300° C. (this having been found in initial tests) and to provide a novel biomaterial (biopolymer) with significantly improved mechanical properties at an acceptable price.

The biomaterial (biopolymer) of the invention can in particular be used in all product segments, and existing tooling can be used without difficulty for processing here.

The aim of the invention, to develop a compounded material (a biomaterial (biopolymer) which has a very high level of biofill and which nevertheless can be processed without difficulty in the form of industrial bioplastic, has been convincingly achieved. Finally, it is also possible, instead of the plastics described (PP, PE, ABS, PVC (polyvinyl chloride), PS (polystyrene), PA (polyamide [preferably of PA6 type])), to admix, or compound, a polylactide (polylactic acid) (abbreviated to PLA) with the sunflower seed shells (the flour from these). The biological content of the entire plastic is thus again increased. PLA plastics per se are already known and are generally composed of many lactic acid molecules chemically bonded to one another, and are members of the polyester class. Polylactide (PLA) plastics are biocompatible.

The present invention aims additionally to protect a compounded material (biocomposite), which is referred to below as PP/SPC 50. What this means in particular is a biocomposite or biomaterial based on sunflower seed shells or sunflower seed hulls, an exact specification of the PP/SPC 50 material being appended as table 6.

This PP/SPC 50-type biomaterial or biocomposite is a compounded material consisting of sunflower seed hull material, is present in a ground form, and preferably has the properties shown in table 7, with a deviation of up to 20% both upward and downward in the individual properties still being situated within the bounds of the invention.

If, therefore, table 7 proposes that the sunflower shell flour is to have a moisture content of 8% or less, it is still within the bounds of the invention if the moisture content is also 10% or less, or 6% or less, and the residual oil content below 3% or below 5%.

An exact formula of the compounded material is appended as table 8, it being the case there as well that deviations of up to 20% both upward and downward from the individual quantity data are still within the range of the invention.

A data sheet for the additive Licocene PP MA 7452 TP is likewise appended, for better comprehension of the invention.

The particularly preferred properties of the biomaterial of the invention are set out in table 6, particular preference attaching to the values for the density, for the elasticity modulus (modulus of elasticity), for the tensile strength, for the elongation at break, for the flexural modulus, for the flexural strength, for the elongation under flexural strain, for the Charpy impact strength and the Charpy notched impact strength. Here again it is the case that values which are within a range of up to 20% both upward and downward of the values listed in table 6 are still within the range of the invention.

The other additives listed in table 8, such as Irganox 1076, for example, are described in table 3; the additive Ciba® IRGAFOS® 168 is described in table 4. The plastics material PP Moplen EP300K is a polypropylene material, and is also described in table 5.

The compounded material of the invention (i.e., the biomaterial of the invention, in other words the biocomposite of the invention) is in particular also suitable for injection molding and therefore suitable for processing at temperatures up to 250° C., also preferably in the range of 210-240° C.

Disclosed by the present application as well, as a further compounded material for producing a biomaterial product according to claim 1, is a biomaterial which is referred to hereinafter as PLA/SPC45. This is a compounded material (biomaterial or biocomposite) which consists of a biopolymer (e.g., Ingeo 2003D) with a mass fraction in the range from 50% to 60%, preferably 55%, and which is developed and produced using a sunflower shell material with a mass fraction in the range from 40% to 50%, preferably 45%, to form a compound. The precise details of one inventive embodiment are described in table 10. Table 11 shows the formula once again in a comprehensible form, and in particular also shows the production of the biomaterial of the invention of the type there designated NaKu XP 100 45SPC.

Table 12 describes further technical data for the product PLA/SPC45 of the invention. Where the polymeric plastic used is the product Ingeo 2003D, this refers to Ingeo™ Biopolymer 2003D from NatureWorks LLC. The data sheet and the individual data for this natural plastic product, Ingeo™ Biopolymer 2003D, can be obtained via the Internet page of NatureWorks LLC, 15305 Minnetonka Blvd., Minnetonka, Minn. 55345. The NatureWorks company is an affiliate of Cargill.

A description of the Ingeo™ Biopolymer 2003D product is appended as table 13. Ingeo™ Biopolymer 2003D is in particular a polylactide (PLA), in other words a plastic based on polylactic acid. The polylactic acid is formed by polymerization of lactic acid, which is in turn a product of the fermentation of sugar and starch by lactic acid bacteria. Polymers are mixed in the polymerization from different isomers of lactic acid, the D and L forms, in line with the desired properties of the resulting plastic. Further properties can be achieved by means of copolymers such as glycolic acid.

Preference is given, moreover, to a method of the invention (as defined above or below and identified as being “preferred/preferable”) where the material of the biomaterial product possesses a yield stress of 20 MPa or more, preferably of 40 MPa or more.

Additionally preferred is a method of the invention (as defined above or below and identified as being “preferred/preferable”) where the biomaterial product has an elongation at break of 3% or greater than 3%, preferably in the range from 4% to 8%, more preferably in the range of the examples stated in the present application.

Especially preferred is a method of the invention (as defined above or below and identified as being “preferred/preferable”) where the biomaterial product possesses a softening temperature in the range from 60 to 80° C., preferably in the range from 70 to 75° C., more preferably of 75° C. This ensures a heat distortion resistance for the compounded material of the invention (biomaterial or biocomposite) at temperatures up to 80° C. still, with the water absorption (tested by boiling over five hours) only in the range from 0.5% to 3%, preferably 1.5%.

The PLA/SPC45-type biocomposite as described in the present application is therefore a purely biodegradable polymer compound based on polylactic acid (PLA) and sunflower seed shell flour, and the biomaterial or biocomposite of the PLA/SPC45 type is suitable in particular for producing injection moldings of all of the aforementioned kinds of product, such as of containers and also vessels, for example. This biomaterial or biocomposite of the invention has not only the capacity for processing by injection molding, but also the mechanical properties reported in table 12 are extremely convincing for numerous applications, and the PLA/SPC45 is notable in particular for a decidedly high modulus of elasticity, a high yield stress, and also a high flexural strength in conjunction with extremely impressive elongation at break.

In accordance with the invention it is possible through the invention as well to produce a biocomposite in which the sunflower shell material is compounded together with a polyamide (PA) material, preferably of the PA6 type. In this case, for example, the fraction of the polyamide material may be preferably in the range from 60% to 80%, preferably about 65% to 75%, more preferably about 68%, and the fraction of the sunflower shell material may be in the range from about 20% to 60%, preferably 30% to 50%. Lastly, the material is also admixed with additives, e.g., with a low percentage fraction, e.g., 0.1% Irgafos 168, about 0.2% Irganox 1076, about 1% Licocene, preferably Licocene of type PP MA, 7452 TP.

It is noted that the fraction of the aforementioned additives may also be varied, and may in each case be in the range between 0.01% to 3%, according to which technical property is required of the biocomposite.

Below: tables 1, 2, 5 to 8 and 10 to 12.

Tables 3, 4, 9 and 13 have already been published and are available via the Internet, and therefore are no longer appended to the filing papers.

For all of the SPC versions of the invention above it is the case that as a result of the incorporation of the sunflower shell fibers into the original plastic, i.e., e.g., PP, PE, PVC, ABS, PLA, PS, PA, etc., a targeted increase can be achieved in the stiffness of the finished plastics product, after injection molding, extrusion, etc., for example, in conjunction with an equal or increased strength of the biomaterial plastics product.

These improved properties relative to the original plastics material, i.e., PP, PE, PVC, ABS, PLA, PS, PA, etc., are extremely advantageous and surprising, and can be achieved at much lower initial costs at the same time, since the costs of a tonne of shell material are a fraction of those of a tonne of petroleum as starting material for the plastics material (PP, PE, etc.).

As already stated—the following likewise applies to all biomaterial compositions disclosed in the present application—the sunflower shells are separated in a shelling process from the inside (kernel) of the sunflower seed. In this operation, it may be the case that kernel residues remain adhering to the shell, and give rise, therefore, to a high fat fraction of up to 8%.

Lastly, it may also be the case as a result that the shells, and also unprocessed fibers of the shells, still have a water fraction of up to 12%, this being not ideal for the production of a composite from plastic and the shells.

By optimizing the shelling operation, then, it is possible to reduce the fat fraction in the shells to below 4% in a targeted way, at the same time ensuring that the shells, which are ground in mills, are at the same time dried to an extent such that the water content desired comes about, such as a water content of below 2%, for example.

After the shelling procedure, the shell fractions are ground and the size that is set, in other words, ultimately, the grain size or else fiber length, then has a desired influence on the elasticity modulus and the tensile strength of the biomaterial of the invention.

The higher the fiber length, the higher as well are the elasticity modulus and the tensile strength achievable in the biomaterial of the invention.

This relationship is shown schematically in FIG. 1.

There is therefore at least the valid principle that the coarser the fiber (=the longer the fiber), the stiffer the biomaterial.

The use of a particular fiber length therefore has consequences for the desired mechanical properties of the biomaterial components of the invention as well.

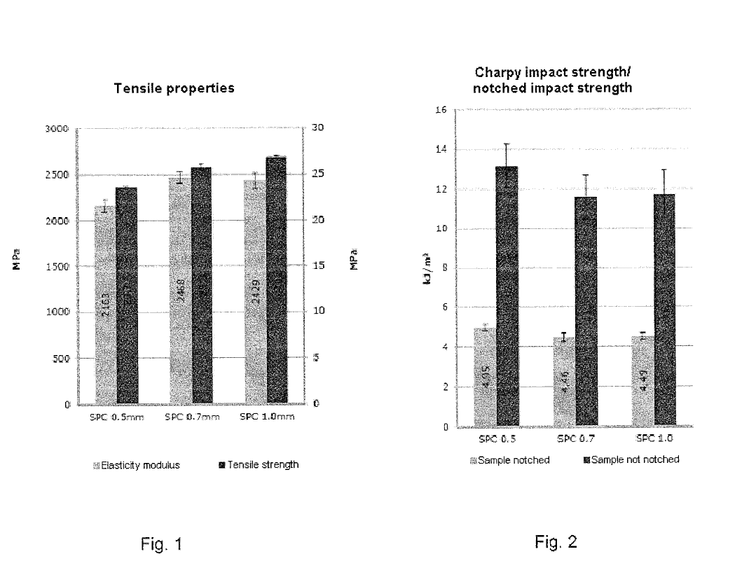

This is also shown in FIG. 2 for the Charpy impact strength/notched impact strength.

Lastly, the fiber properties and/or the SPC material properties and the matrix material can be adapted through selection of the adhesion promoter.

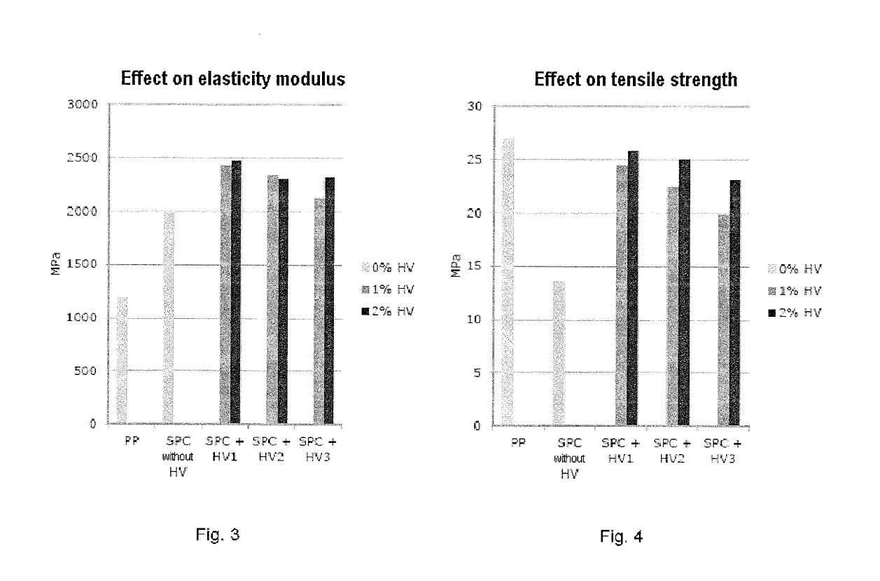

FIGS. 3 and 4 show the effect of the adhesion promoter and its amount on the elasticity modulus and the tensile strength, it being clearly apparent that with an increased use of the adhesion promoter, for example, the tensile strength is always greater than if less adhesion promoter is used.

This is particularly clear when it is seen how great the elasticity modulus and the tensile strength are in the case of an SPC without adhesion promoter (HV).

In particular it is apparent that through the use of the adhesion promoter, it is possible to achieve a significant increase in the elasticity modulus relative to a PP without adhesion promoter or to an SPC without adhesion promoter.

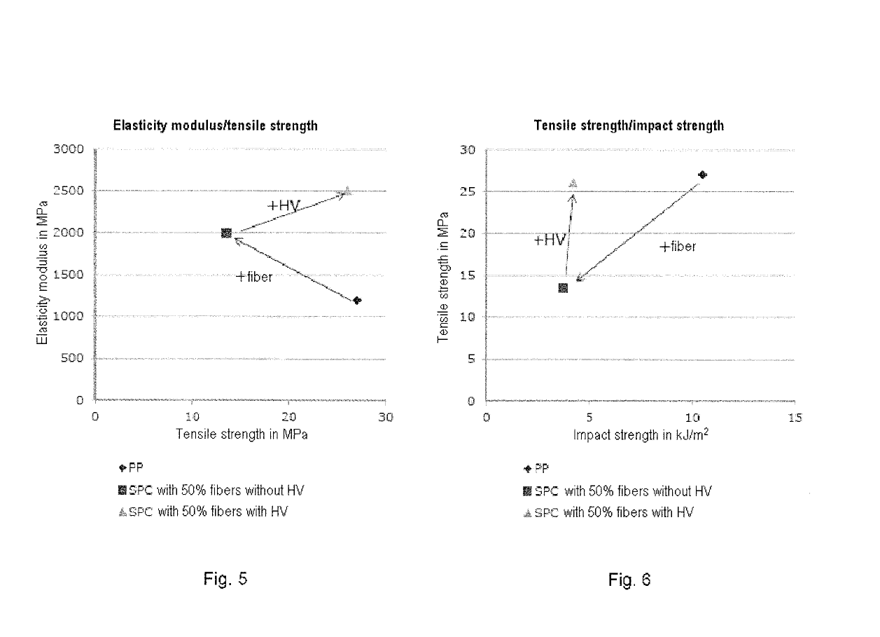

In a diagram, FIGS. 5 and 6 show the measures by which the elasticity modulus can be influenced, starting for example from the virgin plastics product such as PP (polypropylene), in terms of the tensile strength or tensile strength/impact strength, respectively.

For instance, FIG. 5 shows that, starting from the virgin PP, the elasticity modulus can be increased significantly by an increased fiber length, and so, for example, the elasticity modulus of the tensile strength increases significantly for an SPC with 50% fibers even without adhesion promoter. Through the use of a corresponding adhesion promoter, the elasticity modulus can then be increased once again.

The diagram also shows that through the use of the fibers, starting from the virgin PP product, the tensile strength is first of all reduced, but can be raised again, almost to the original level, through the use of a corresponding adhesion promoter.

The corresponding relationships are then also shown by FIG. 6. Starting from the virgin polypropylene plastic (PP), the addition of fibers, such as of 50% sunflower shell fiber, initially reduces the tensile strength (this is also already known from FIG. 5) and, through the use of a corresponding adhesion promoter, it is then possible to ensure that the tensile strength regains its so-to-speak former level of the virgin PP.

At the same time, however, the impact strength of the SPC product with 50% fibers and with adhesion promoters is lowered relative to the virgin PP product—in the example shown, from about 12 kJ/m² to about 4 kJ/m².

As already observed, suitable adhesion promoters include, among others, maleic anhydride (MAH) grafted polymers. Maleic anhydride reacts, with elimination of water, with the OH groups of the natural fiber—in other words, in the example in the present application, with the fiber of the sunflower shell—and in so doing it forms a covalent bond. This bond ensures effective adhesion between fiber and matrix.

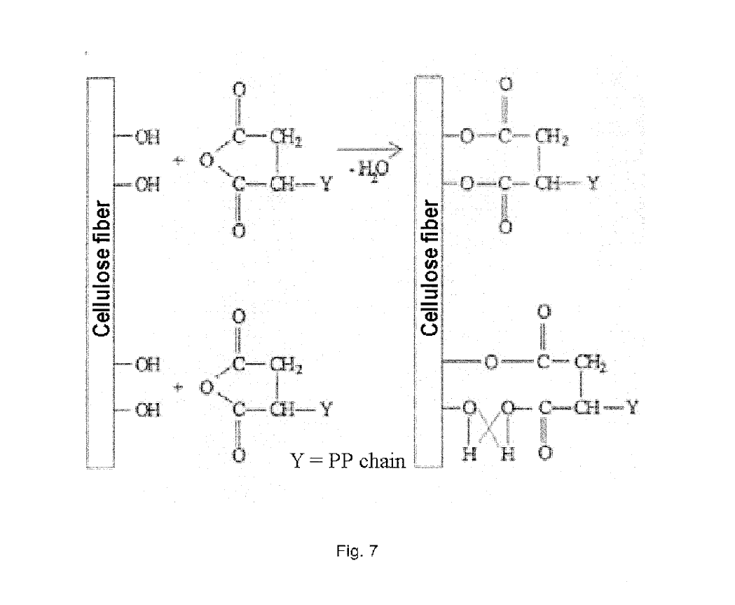

FIG. 7 shows one example of this.

Maleic anhydride (MAR), however, cannot be grafted ad infinitum onto polymer chains.

Typical adhesion promoters have MAH contents of between 0.5% and 1.5%, some of them well above 2%. The effectiveness of the adhesion promoters cannot be read solely from the MAH content, however.

The compatibility of the adhesion promoters with the polymer matrix thus also plays a part, as do the flow behavior of the adhesion promoters, and the nature and location of their metered addition into the compound.

The SPCs of the invention are produced on modern, corotating twin-screw extruders with a high specific torque and high L/D.

The fiber is metered in as far as possible upstream, in order to have a great deal of time for the devolatilizing and low-shear dispersing of the fiber in the melt. The SPC intermediate is pelletized generally by underwater and water-cooled die-face pelletization, and strand pelletization is also possible.

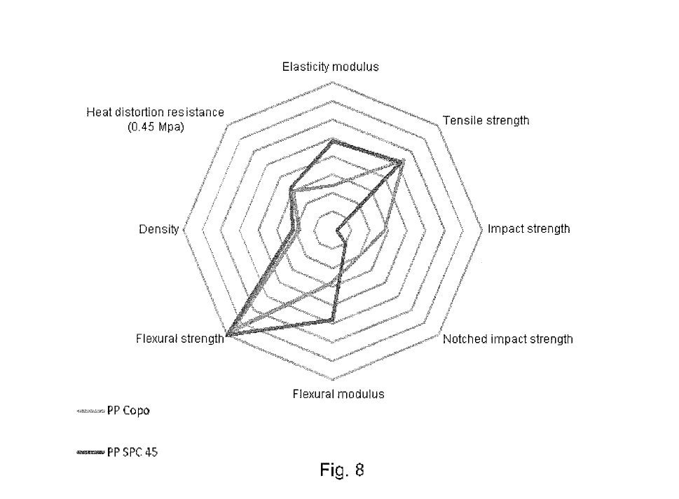

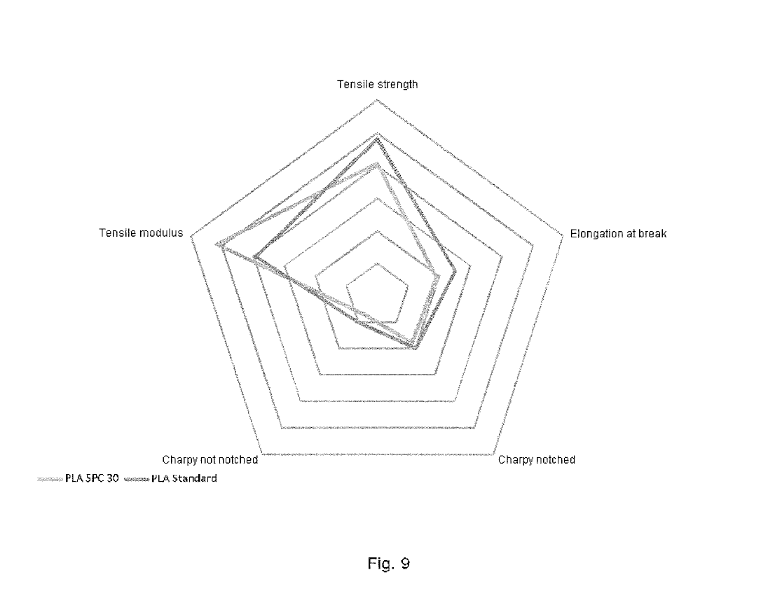

FIG. 8 shows the example of a standard product in injection-molding grade, based on a PP random copolymer (PP Copo), in comparison to an inventive PP SPC 45 material, i.e., a material with 45% sunflower shell fibers.

The PP SPC 45 material of the invention is hardly any different from the PP Copo copolymer material with regard to parameters such as flexural strength, density and heat distortion resistance.

In contrast, with regard to the elasticity modulus and to the flexural modulus, it has significantly enhanced properties, whereas the impact strength is at and below that of PP Copo.

FIG. 9 shows the presentation of a PLA SPC 30 in comparison with a PLA standard. The PLA SPC 30 has a much higher tensile strength and elongation at break than the PLA standard material.

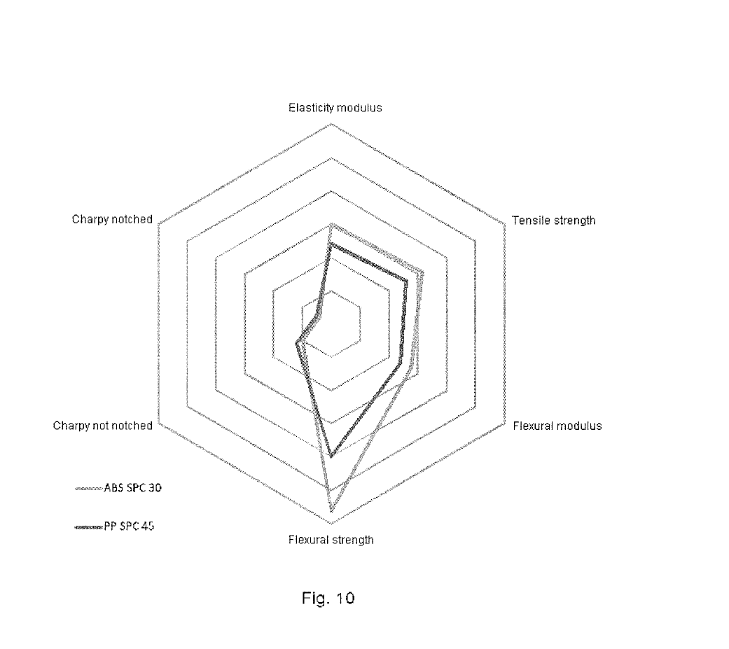

FIG. 10 shows the contrasting of ABS SPC 30 and PP SPC 45.

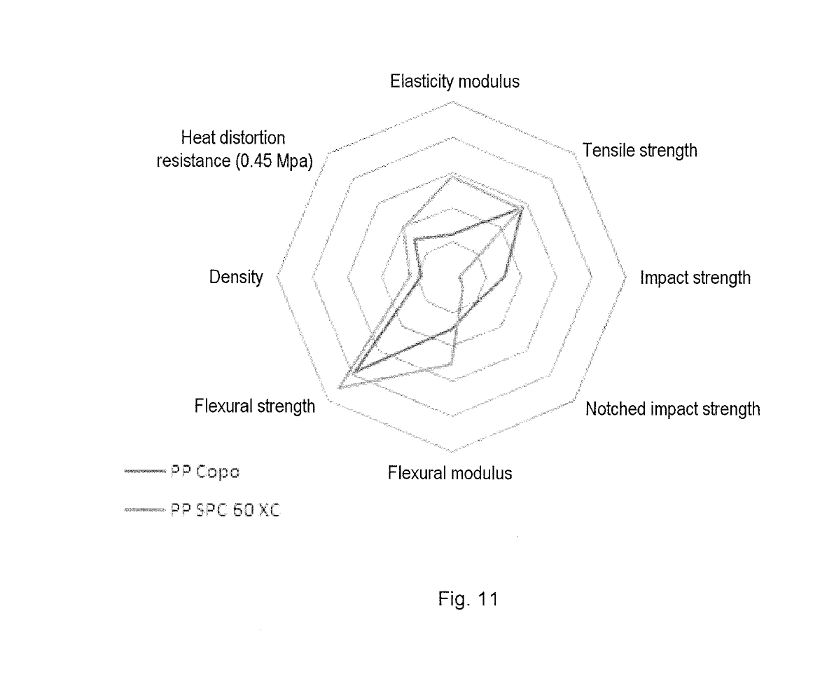

FIG. 11, lastly, shows the comparison of a PP SPC 60 XC with a standard PP copolymer. PP SPC 60 XC here means that 60% of the material is formed by sunflower shell fiber material. Here again it is evident that the flexural strength, the heat distortion resistance, the elasticity modulus, and the flexural modulus are well above those of the PP copolymer, while the notched impact strength is reduced slightly and the impact strength is reduced significantly. The tensile strength is virtually unchanged.

As mentioned, for all of the examples described above, the values for elasticity modulus, tensile strength, impact strength, notched impact strength, flexural modulus, flexural strength, density, and heat distortion resistance can be influenced by the selection of the adhesion promoter, the amount thereof, and also by the selected fiber length quality and/or the amount of the fiber fraction, in the desired way, to produce a biocomposite material which both on injection molding and on extrusion can be processed in the desired way to a plastics end product which has the desired properties recited in the figures described above.

TABLE 1
Technical Data Sheet
Issue July 2011
SCONA TPPP 8112 FA
Adhesion modifier for polypropylene-natural fiber
compounds and in TPE-S compounds
Chemical structure

| SCONA TPPP 8112 FA | Polypropylene, highly functionalized | | |
|---|---|---|---|
| | with maleic anhydride | | |
| Properties | | | |
| | Melt index in | | |
| | g/10 min | Loss on | |
| | (MFI 190° C., | drying in % | MA content |
| | 2.16 kg) | 3 h/110° C. | in % |
| SCONA TPPP 8112 FA | >80 | >0.5 | 1.4 |

The values stated are typical, but do not represent a
specification.
Recommended addition quantities

| | Addition quantity in % of supply |
|---|---|
| | form, based on entire formulation |
| SCONA TPPP 8112 FA | From 0.8 to 3, dependent on natural |
| | fiber content and on PP content in |
| | TPE-S compound |

Incorporation and procedure
Homogeneous dispersion of the modifier in the compound
Application sectors

| SCONA TPPP 8112 FA | Coupling agent in polypropylene- |
|---|---|
| | natural fiber compounds |
| | Adhesion modifier in TPE-S |
| | compounds |
| Properties and advantages | |
| SCONA TPPP 8112 FA | Good flow properties in highly |
| | filled TPE-S compounds |
| | Significant improvement in |
| | mechanical properties in |
| | polypropylene-natural fiber compounds |
| | Reduction of water absorption in |
| | polypropylene-natural fiber compounds |
| | Good suitability for masterbatch |
| | production |

Notes
Supply form: Powder
Storage and transport

| | |
|---|---|
| SCONA TPPP 8112 FA | Storage temperature max. 35° C. |
| | Relative humidity <80% |
| | Avoid direct exposure to sunlight |
| | and avoid contact with water |

TABLE 2
Data Sheet X506
Issue March 2010

| BYK-P 4200 | | | |
|---|---|---|---|
| Stripping agent to reduce odor and VOC emissions in | | | |
| thermoplastic compounds | | | |
| Chemical structure | | | |
| BYK-P 4200 | Aqueous solution of polymeric, | | |
| | surface-active substances adsorbed on | | |
| | a polypropylene carrier | | |
| Properties | | | |
| | | MVR in accordance | Bulk |
| | Melting | with ISO 1133 | density |
| | point in ° C. | cm³/10 min | kg/m³ |
| BYK-P 4200 | 160 | 25 | 370 |

| The values stated are typical, but do not represent a | |
|---|---|
| specification. | |
| Recommended addition quantities | |
| | Additive quantity in % of supply |
| | form, based on entire formulation |
| BYK-P 4200 | From 0.5 to 2.0% |

| Incorporation and procedure | | | |
|---|---|---|---|
| BYK-P 4200 should be added to the plastic during or | | | |
| prior to compounding process | | | |
| Application sectors | | | |
| | Polypropylene | Polyethylene | ABS |
| BYK-P 4200 | ▪ | ▪ | □ |

| ▪ particularly recommended application sector | |
|---|---|
| □ recommended application sector | |
| Function | |
| The effect of adding BYK-P 4200 is to reduce the level of | |
| compound constituents that cause odor and emissions, or even | |
| to remove these entirely, during vacuum devolatilization. | |
| Properties and advantages | |
| BYK-P 4200 | Major reduction in level of odor |
| | and VOC emissions |
| | No adverse effect on mechanical and |
| | optical properties |
| | No additional capital expenditure |
| | necessary for plant extensions |
| | Easy to use |

Notes
To achieve efficient performance of the additive,
vacuum devolatilization using at least 100 mbar is
recommended. Wherever possible, operations should use
only one vent shortly before the end of the extruder.

TABLE 5
Material Data Center|Data Sheet Moplen EP300K

Home Imprint About
Material Data Center is a leading international
information system for the plastics industry. Material
Data Center offers a comprehensive plastics database,
calculation tools, CAE interfaces, a literature
database and an application database. For more
information about Material Data Center visit
www.datacenter.com
This is the free Material Data Center Data Sheet of
Moplen EP300K - PP - LyondellBasell Industries
Material Data Center offers the following functions for
Moplen EP300K:
unit conversion, PDF data sheet print, direct
comparison with other plastics, snap fit calculation,
beam deflection calculation
Review here of other Moplen information available in
Material Data Center.
Use the following short links to get directly to the
properties of interest in this data sheet:

| ISO Data | Value | Unit | Test Standard |
|---|---|---|---|
| Rheological properties | | | |
| Melt volume-flow rate | 5.4 | cm³/10 min | ISO 1133 |
| (MVR) | | | |
| Temperature | 230 | ° C. | ISO 1133 |
| Load | 2.16 | kg | ISO 1133 |
| Melt flow index (MFI) | 4 | g/10 min | ISO 1133 |
| MFI temperature | 230 | ° C. | ISO 1133 |
| MFI load | 2.16 | kg | ISO 1133 |
| Mechanical properties | | | |
| Tensile modulus | 1200 | MPa | ISO 527-1/-2 |
| Yield stress | 27 | MPa | ISO 527-1/-2 |
| Yield elongation | 7 | % | ISO 527-1/-2 |
| Elongation at break | 50 | % | ISO 527-1/-2 |
| Charpy impact strength | N | kJ/m² | ISO 179/1eU |
| (+23° C.) | | | |
| Charpy notched impact | 10.5 | kJ/m² | ISO 179/1eA |
| strength (+23° C.) | | | |
| Ball indentation | 53 | MPa | ISO 2039-1 |
| hardness | | | |
| Thermal properties | | | |
| Temp. of deflection | 75 | ° C. | ISO 75-1/-2 |
| under load (0.45 MPa) | | | |
| Vicat softening point | 150 | ° C. | ISO 306 |
| (A) | | | |
| Vicat softening point | 71 | ° C. | ISO 306 |
| (50° C./h 50 N) | | | |
| Other properties | | | |
| Density | 900 | kg/m³ | ISO 1183 |
| Characteristics | | | |
| Processing methods | | | |
| Injection molding, | | | |
| other extrusion, | | | |
| thermoforming | | | |
| Special characteristics | | | |
| High impact/impact | | | |
| modified | | | |
| Features | | | |
| Impact copolymer | | | |
| Applications | | | |
| General purpose | | | |
| Regional availability | | | |
| Europe, Middle | | | |
| East/Africa | | | |

### DISCLAIMER

Copyright M-Base Engineering+Software GmbH. M-Base Engineering+Software GmbH assumes no liability for this information to be free of errors. The user takes sole responsibility for the use of this data under the exclusion of every liability from M-Base GmbH; this is especially valid for claims of compensation resulting from consequential damages. M-Base explicitly points out that any decision about use of materials must be double checked with the producer of this material. This includes all contents of this system. Copyright laws are applicable for the content of this system.

Material Data Center is provided by M-Base Engineering+Software GmbH. M-Base Engineering+Software GmbH assumes no liability for the system to be free from errors. Any decision about use of materials must be checked in detail with the relevant producer.

Additional information about this material, for example substance group, producer contact address, and also in some cases data sheets and application examples can be found at www.materialdatacenter.com. Some of the information is restricted to registered users. On the Start page there is a link to free registration.

http://www.materialdatacenter.com/ms/de/Moplen/Lyondell Basell+Industries/Moplen . . . Jul. 19, 2012

TABLE 6
Product data sheet
PP/SPC50
The idea: Sunflower oil in the “original packaging” of
the sunflower shell.
The raw sunflower seed hull material, as a byproduct of
sunflower processing, is climate-neutral as a result of
the closed CO₂ cycle.
By means of SPC it is possible to realize processing
temperatures of up to 250° C. Hence the use of the
polymer matrix PP, ABS and PA with SPC is possible.
This enables us to use SPC in various sectors of industry.

| | | | Value, |
|---|---|---|---|
| Property | Standard | Unit | dry |
| Mechanical properties: | | | |
| Density | ISO 1183 | g/cm³ | 1.07 |
| MVR | ISO 1183 | cm³/10 min | 1.2 |
| | (190° C./2.16 kg) | | |
| Elasticity modulus | ISO 527 | MPa | 2400 |
| Tensile strength | ISO 527 | MPa | 24.5 |
| Elongation at break, nominal | ISO 527 | Wo | 4.1 |
| Flexural modulus | ISO 178 | MPa | 2400 |
| Flexural strength | ISO 178 | MPa | 40 |
| Elongation under flexural | ISO 178 | % | 4.5 |
| strain (max.) | | | |
| Charpy impact strength 23° C. | ISO 179/1eU | kJ/m² | 12 |
| Charpy notched impact | ISO 179/1eA | kJ/m² | 3.6 |
| strength 23° C. | | | |
| Thermal properties/other: | | | |
| Vicat softening point/B | ISO 306 | ° C. | 75 |
| Heat distortion resistance | ISO 75-1 | ° C. | 79 |
| | (0.45 MPa) | | |
| Water absorption (boil 5 h) | ISO 62 - | | 1.5 |
| | method 2 | | |
| Processing conditions: | | | |
| Melt temperature, injection | | ° C. | 190 |
| molding | | | |
| Mold wall temperature | | ° C. | 30 |

TABLE 7
Specification/product data sheet

| | |
|---|---|
| Product name: | sunflower shell flour |
| Manufacturer: | Goldene Muhle GmbH/QS ID: |
| | 4031735000463 |
| Origin of raw material: | Europe |
| Product description: | finely ground sunflower shells |
| Production process: | shells arising in the shelling |
| | of selected sunflower kernels |
| | are pressed mechanically into |
| | pellet form and then ground. |
| | The shells are not heat- |
| | treated beforehand, and no |
| | binders are added. |
| Article number: | |
| Packaging: | loose in BigBags 1000 kg |
| Declaration: | product name, article number, |
| | LOT number, weight |
| Storage: | cool <20° C., dry, closed |
| | container |
| UBD use-by date: | unlimited keeping under |
| | standard conditions 20° C., |
| | closed container |
| Use: | as biological filler in |
| | plastics production |

Sensory properties:

| | |
|---|---|
| Shape | flourlike with grain size |
| | <300 mμ (film application)/ |
| | <700 mμ (injection molding) |
| Color | gray-brown |
| Structure | fine flour, produces dust |
| | during wrapping |
| Odor | pleasant, typical sunflower |
| | odor, no extraneous odors |

Physical properties:

| | |
|---|---|
| Moisture content | ≦8% |
| Residual oil content | <4% |
| Bulk density | <1 kg/l |
| Density | |

Chemical properties:

| | |
|---|---|
| Hydrogen | 6% according to DIN 51732 |
| Others | free from chemical additives |
| Irradiation | the product is not ionized |

Contaminates/pollutants: according to DIN 53770,
parts 1, 2, 3, 5, 6 and 13

| | |
|---|---|
| Heavy metals | lead ≦0.01% |
| | arsenic ≦0.01% |
| | mercury ≦0.0005% |
| | cadmium ≦0.01% |
| | antimony ≦0.005% |

Safety notes:
The sunflower shell flour is nontoxic and biodegradable.
In water bodies, raises the chemical (COD) and biological (BOD) oxygen demand.
In the soil, reduces water penetration.

TABLE 8
PP/SPC 50
based on final formula 13.05.2013
Basis: 1 tonne
Product: PP/SPC 50
Formula 5

| Component/operation | in % | Amount (kg) |
|---|---|---|
| PP Moplen EP 300 K, pellets | 53.70% | 537.00 |
| Shells | 45.00% | 450.00 |
| Irgafos 168, powder | 0.10% | 1.00 |
| Irganox 1076, powder | 0.20% | 2.00 |
| OA 6010 powder | 0.00% | 0.00 |
| Licocene PP MA 7452 TP | 1.00% | 10.00 |
| Compounding | | 1000.00 |
| Toll grinding | | 450.00 |
| Total | 100.00% | 1000.00 |

TABLE 10
Compound - data sheet
Extruder: Leistritz ZSE 27
MX - 40D
Tooling: Circular die, single, .4 mm
Screw configuration: standard
Side feed: twin screw

| | | | | | Mass |
|---|---|---|---|---|---|
| | Metering | Designation | | Mass | flow rate |
| | material | of material | Batch | fraction % | [kg/h] |
| Gravimetric | Polymer | Ingeo 2003D | — | 55 | 5.5 |
| metering 1 | | | | | |
| Gravimetric | Filler | Sunflower | — | 45 | 4.5 |
| metering 2 | | 4% oilant | | | |

| Temperature profile | | | | | |
|---|---|---|---|---|---|
| Zone | Target | ACTUAL | | | |
| E 1 [° C.] | 100 | 101 | Rotary speed, | [U/min] | 270 |
| E 2 [° C.] | 155 | 155 | main extruder | | |
| E 3 [° C.] | 165 | 147 | Rotary speed, | [U/min] | 50 |
| E 4 [° C.] | 165 | 165 | side feed | | |
| E 5 [° C.] | 165 | 165 | Motor level | [%] | 34-41 |
| E 6 [° C.] | 165 | 160 | (main extruder) | | |
| E 7 [° C.] | 165 | 165 | Melt pressure | [bar] | 30-33 |
| E 8 [° C.] | 165 | 165 | Vacuum pump | [bar] | — |
| E 9 [° C.] | 165 | 165 | Cooling-bath | [m] | 0.4 |
| E 10 [° C.] | 185 | 185 | section | | |
| E 11 [° C.] | 185 | 170 | Rotary speed, | [°O] | 38 |
| Tmelt [° C.] | — | 171 | pelletizer | | |

Notes
PLA if pre-dried (8 hours)
Steam given off at die exit
Slight drooling at die exit
Processing without sieve insert
Compressed-air drying after cooling-bath section
Low melt stiffness (very sensitive to filler fraction → max. 45%) and bridging of filler → frequent breaking of the polymer strand, Metering nonuniform (gravimetry must be regularly checked!)

TABLE 11
- PLA/SPC 45 -
Formula and production
NaKu XP 100 45 SPC

Materials:
55% PLA from Nature Works Ingeo type: 2003D
45% sunflower as per SPC, degree of grinding 0.3 to 0.5 mm
In order to maximize the biological nature of the
material and to ensure the maximum fraction of
renewable raw materials and effective biocompatibility
on decomposition, no adhesion promoter was used.
Preparation of material:
Drying of Ingeo 2003D overnight at 70° C. for 8 h
Drying of sunflower approximately 2% moisture content,
drying in vacuum oven
Start-up difficulties (fume hood, strand cooling, and
tearing) last for 2 hours; the material will have
picked up moisture again and probably not with
Machine configuration
Intake:
Metering of PLA and sunflower by the main intake.
Side metering facility ran empty at same time
Limiting factor was the conveying of the sunflower
flour into the screw.
Bridging, although the Leistritz ZSE 27MX has
especially deep screw flights in the intake, only 50%
of maximum output

TABLE 12
Naku
Technical data sheet NaKu XP100 SPC45 Version 1.0
Product: NaKu XP100 SPC45
Application: injection molding
1 Designation, use

| a) Commercial | development code no | | |
|---|---|---|---|
| designation: | coding commercially as yet | | |
| b) Use: | biodegradable polymer | | |
| | compound based on poly- | | |
| | lactic acid/sunflower | | |
| | shells; manufacture of | | |
| | injection-molded parts | | |
| | e.g. vessels | | |
| Test content | Test method | Unit | Value |

2 Mechanical properties:

| | | | |
|---|---|---|---|
| Density (23° C.) | DIN 53479 | g/cm³ | n.a. |
| Elasticity modulus | ISO 527-2 | MPa | 4500 |
| Yield stress | ISO 527-2 | MPa | 45.1 |
| Flexural modulus | ISO 178: 2011 | MPa | 4900 |
| Flexural strength | ISO 178: 2011 | IMPa | 85 |
| Notched impact strength, | ISO 180/1A | kJ/m² | n.a. |
| notched (23° C.) | | | |
| Elongation at break | DIN 534525 | % | 6.7 |

3 Thermal properties:

| | | | |
|---|---|---|---|
| Heat distortion resistance | DIN 53461 | ° C. | n.a. |
| 1.89 Mpa | | | |

4 Other properties:

| | |
|---|---|
| Color | brown |

1. A method for producing a biomaterial product based on
sunflower seed shells or sunflower seed hulls, comprising the following steps:
providing or producing a compounded material,
the material resulting from compounding of a sunflower seed shell material or sunflower seed hull material with a plastics material,
and
processing the compounded material, or a compounded material resulting therefrom by treatment, at a temperature of 260° C. or less to form a biomaterial product,
the total fraction of sunflower seed shell material or sunflower seed hull material in the biomaterial product being in the range from 20 to 60 wt %, based on the total mass of the biomaterial product, and
the biomaterial product preferably possessing
a density of 1 g/cm³ or greater than 1 g/cm³, and/or
an elasticity modulus of 1000 MPa or greater than 1000 MPa, and/or
a tensile strength of 10 MPa or greater than 10 MPa, and/or
an elongation at break of 3% or greater than 3%.

2. The method of claim 1,
the fraction of the sunflower seed shell material or sunflower seed hull material in the biomaterial product being in the range from 30 to 50 wt %, based on the total mass of the biomaterial product, preferably 45 wt %, based on the total mass of the biomaterial product.

3. The method of claim 1 or 2,
the plastics material being selected from the group consisting of polypropylene (PP), polyethylene (PE), polyvinyl chloride (PVC), acrylonitrile-butadiene-styrene (ABS), polylactide (PLA), polystyrene (PS), polyamide (PA), and mixtures thereof.

4. The method of any of the preceding claims,
the processing of the compounded material taking place at a temperature of 255° C. or less, 250° C. or less, 240° C. or less, more preferably at a temperature in the range from 100° C. to 260° C., preferably in the range from 150° C. to 250° C.

5. The method of any of the preceding claims,
the biomaterial product possessing an elasticity modulus of 2000 MPa or greater than 2000 MPa.

6. The method of any of the preceding claims,
the biomaterial product possessing a tensile strength of 20 MPa or greater than 20 MPa.

7. The method of any of the preceding claims,
the processing of the compounded material, or of a compounded material resulting therefrom by treatment, to form a biomaterial product taking place by means of one, two or more, or all methods selected from the group consisting of
extrusion, injection molding, rotomolding, press techniques, and thermoforming methods.

8. The method of any of the preceding claims, the sunflower seed shell material or sunflower seed hull material possessing
a water fraction in the range from 1 to 10 wt %, preferably in the range from 4 to 8 wt %, more preferably in the range from 5 to 7 wt %,
and/or
a grain size in the range of 3 mm or less, preferably in the range from 0.01 to 1 mm, more preferably in the 0.1 to 0.3 mm range, and so
the elasticity modulus and/or the tensile strength of the biomaterial product are increased,
and/or
a fat fraction of 6 wt % or less, preferably of 4 wt % or less, more preferably in the range between 1 to 2 wt %,
based in each case on the total mass of the sunflower seed shell material or sunflower seed hull material.

9. The method of any of the preceding claims,
the biomaterial product having a softening temperature in the range from 50 to 80° C., preferably not greater than 75° C.

10. The method of any of the preceding claims,
the material resulting from compounding of a sunflower seed shell material or sunflower seed hull material with a polyamide, preferably of type PA6, and also one, two, or more than two additives, preferably of the type Irgafos 168 and/or Irganox 1076 and/or Licocene, preferably of type PP MA, 7452 TP,
wherein
the fraction of the polyamide is in the range from 65 to 75 wt %, based on the total mass of the biomaterial product,
and
the fraction of the sunflower seed shell material or sunflower seed hull material is in the range from 28 to 35 wt %, based on the total mass of the biomaterial product.

11. The use of a compounded material (SPC, sunflower-plastic composite) as defined in any of claims 1 to 9 for producing a biomaterial product as defined in any of claims 1 to 9,
the biomaterial product preferably forming, or being a constituent of, a packaging item, a furnishing item, a layable sheetlike element, and an automobile part.

12. The use of claim 11,
the packaging being food packaging, preferably a canister or a bottle or a film.

13. The use of claim 11 or 12, the compounded material being used for producing
doors, pots, flower planters, boxes, transport boxes, or containers.

14. The use of any of claims 11 to 13,
the layable sheetlike element being a flooring or patio board, preferably decking.

15. A biomaterial product producible by a method of any of claims 1 to 10.
